(19) United States
(12) Patent Application Publication
(10) Pub. No.: US 2026/0365260 A1
(43) Pub. Date: Nov. 19, 2026

(54) CAR SPOILER

(71) Applicant: SENG KIAT GOH, Lorong LAKSAMANA CHENG HO (MY)

(72) Inventor: SENG KIAT GOH, Lorong LAKSAMANA CHENG HO (MY)

(21) Appl. No.: 19/211,145

(22) Filed: May 17, 2025

(51) Int. Cl. B62D 35/00; B60Q 1/00; B60Q 1/44

(52) U.S. Cl. CPC B62D 35/007; B60Q 1/0035; B60Q 1/44

(57) ABSTRACT

A car spoiler includes a rear wing, two supporting arms, at least one main body and two rear wing panels. The two supporting arms are fixed on a car, the two supporting arms are combined with the main body, and the left and right sides of the main body are respectively combined with one rear wing panel. At least one track is provided at the bottom of the main body, and a track opening is provided between the track and the main body. A plurality of attachable base blocks are slidably provided on the track, and the attachable base blocks can be combined with any number of attachment pieces. The attachment piece is provided with at least one assembly portion fixed to the main body by using a plurality of screws to pass through the track opening and lock with the attachment piece, and the attachment piece is fixed.

### BACKGROUND OF THE INVENTION

### Field of Invention

The present invention relates to a car spoiler, and more particularly to a car rear wing structure.

### Description of the Related Art

In order to make the car run more smoothly, the rear wing can be installed at the rear of the car to guide the air flow, which increases car's grip and plays a balancing role. In order to make the car run more conveniently, many external parts will be installed on the car body to add more functions to the car body to assist driving. However, these external parts are numerous and require space for installation. Installing external parts directly on the car body may damage the original structure, which is what most consumers are unwilling to do. If the external parts are installed on the rear wing, it may increase consumer acceptance, reduce modification costs, and facilitate maintenance by the industry.

Therefore, it is desirable to provide car spoiler for a grinding machine to mitigate and/or obviate the aforementioned problems.

### SUMMARY OF THE INVENTION

An objective of present invention is to provide car spoiler, which is capable of improving the above-mention problems.

In order to achieve the above-mentioned objective, a car spoiler includes a rear wing, two supporting arms, at least one main body and two rear wing panels. The two supporting arms are fixed on a car, the two supporting arms are combined with the main body, and the left and right sides of the main body are respectively combined with one rear wing panel. At least one track is provided at the bottom of the main body, and a track opening is provided between the track and the main body. A plurality of attachable base blocks are slidably provided on the track, and the attachable base blocks can be combined with any number of attachment pieces. The attachment piece is provided with at least one assembly portion fixed to the main body by using a plurality of screws to pass through the track opening and lock with the attachment piece, and the attachment piece is fixed.

Other objects, advantages, and novel features of invention will become more apparent from the following detailed description when taken in conjunction with the accompanying drawings.

### BRIEF DESCRIPTION OF THE DRAWINGS

FIG. 1 is a perspective view of a preferred embodiment according to the present invention.

FIG. 2 is an exploded view of the preferred embodiment according to the present invention.

FIG. 3 is a top view of the plan view of the preferred embodiment according to the present invention.

FIG. 4 is a partial cross-sectional enlarged view of the assembly portion of the attachment piece of the preferred embodiment according to the present invention.

FIG. 5 is another aspect of enlarged partial cross-sectional view of the assembly portion of the attachment piece of the preferred embodiment according to the present invention.

FIG. 6 is a three-dimensional diagram of the present invention from another angle.

FIG. 7 is a schematic diagram showing that the attachment piece is a guide plate according to the present invention.

FIG. 8 is a partial cross-sectional enlarged view of the assembly portion of the attachment piece as a guide plate according to the present invention.

FIG. 9 is a schematic diagram showing that one tracks of the main body according to the present invention.

FIG. 10 is a schematic diagram showing a plurality of main bodies according to the present invention

### DETAILED DESCRIPTION of PREFERRED EMBODIMENT

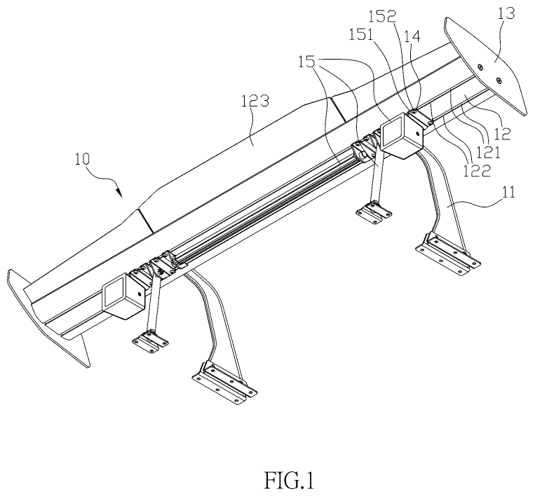

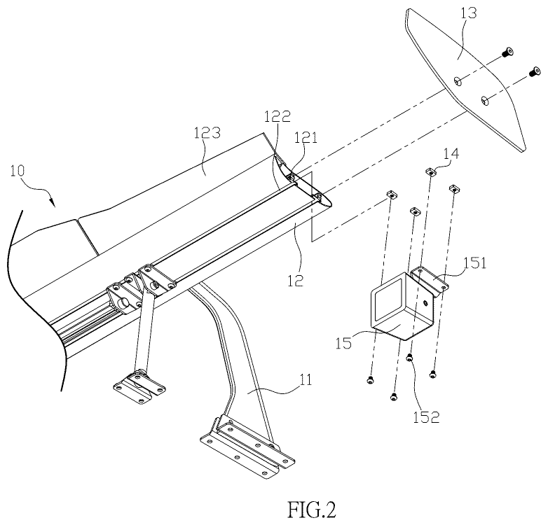

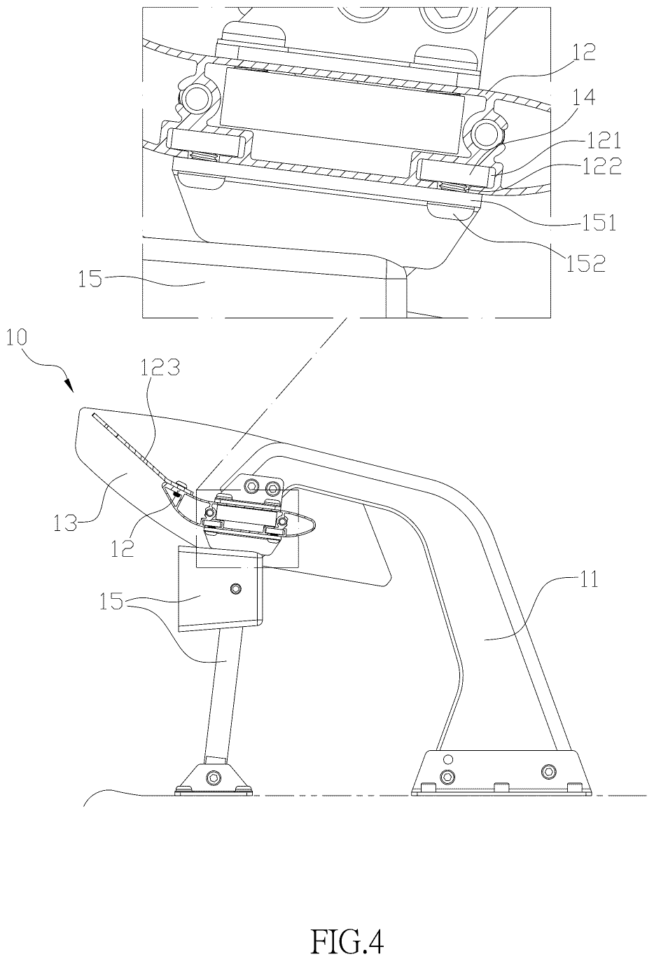

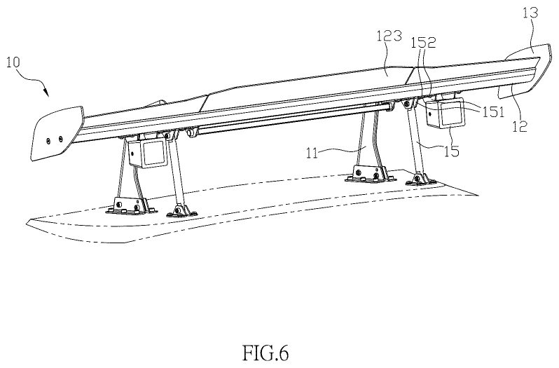

First, please refer to FIGS. 1 to 6. A car spoiler comprises a rear wing 10, and the rear wing 10 comprises two supporting arms 11, at least one main body 12 and two rear wing side parts 13. The two supporting arm 11 are configured for being attached to the car 20, the two supporting arm 11 is combined with the main body the main body 12, and a left side and a right side of the main body 12 are respectively combined with one the rear wing. At least one track 121 is provided at a bottom of the main body 12, and a track opening 122 is disposed between the track 121 and the main body 12. A plurality of attachable base blocks 14 are slidably attached to the track 121, and the attachable base blocks 14 are capable of being combined with at least one attachment piece 15. Each of attachment piece 15 has at least one assembly portion 151 locked with the attachment piece 15 through the track opening 122 by a plurality of screws 152 to secure the attachment piece 15 onto a bottom of the main body 12. According to the different functions of the attachment piece 15, a user can chose different attachment pieces 15 to adjust the structure of the rear wing 10 or to help the vehicle 20 to travel, and the main body 12 can be installed with any number of the rear wing panels 123.

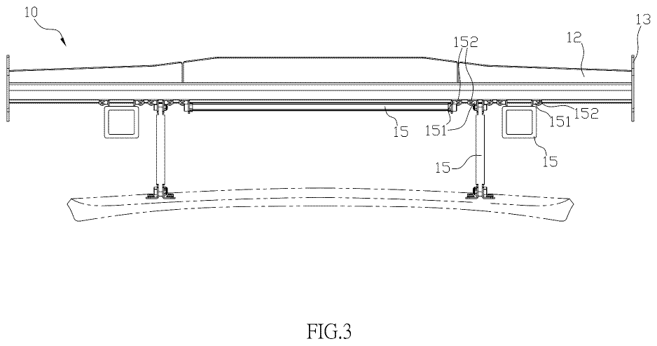

As shown in FIG. 3, the at least one attachment piece 15 comprises a fog light the attachment piece 15.

As shown in FIG. 3, the attachment piece 15 comprises a rear braking light.

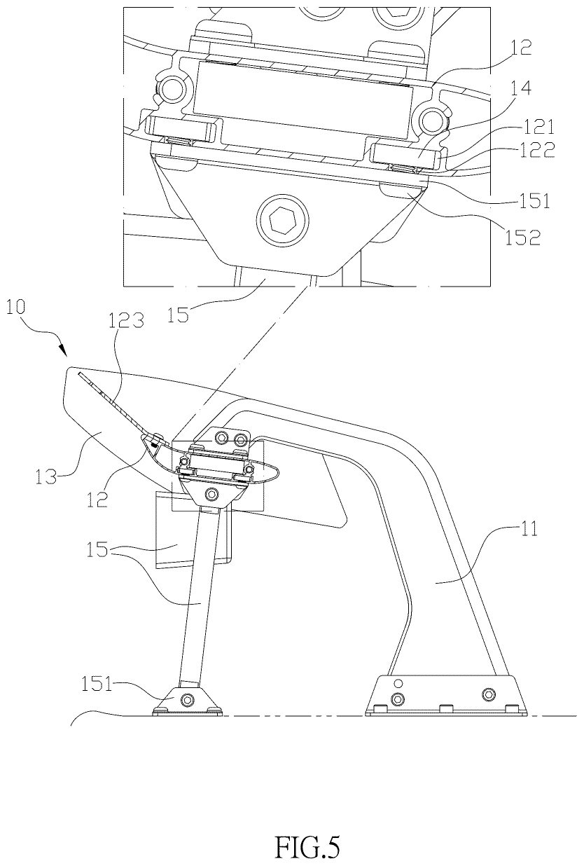

As shown in FIG. 5, the attachment piece 15 is an adjustment lever, and both of opposite ends of the attachment piece 15 respectively have one assembly portion 151 capable of pivoting relative to the attachment piece 15, and another end of the assembly portion 151 of the attachment piece 15 is secured to the car 20. The attachment piece 15 is assembled between the main body 12 and the car 20 to strengthen the structure. The assembly portion 151 can be pivoted relative to the attachment piece 15 to flexibly adjust the installation to adjust the angle and height of the main body 12, and the rear wing panel 123 can adjust the airflow at the rear of the car 20.

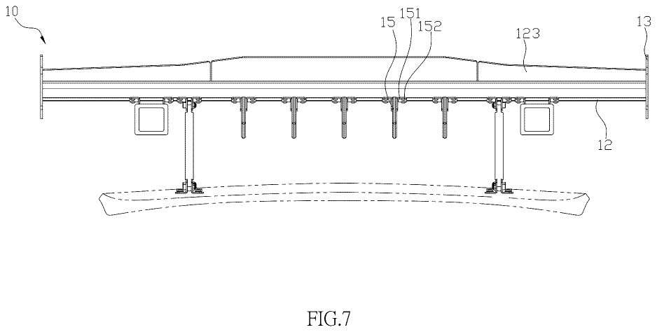

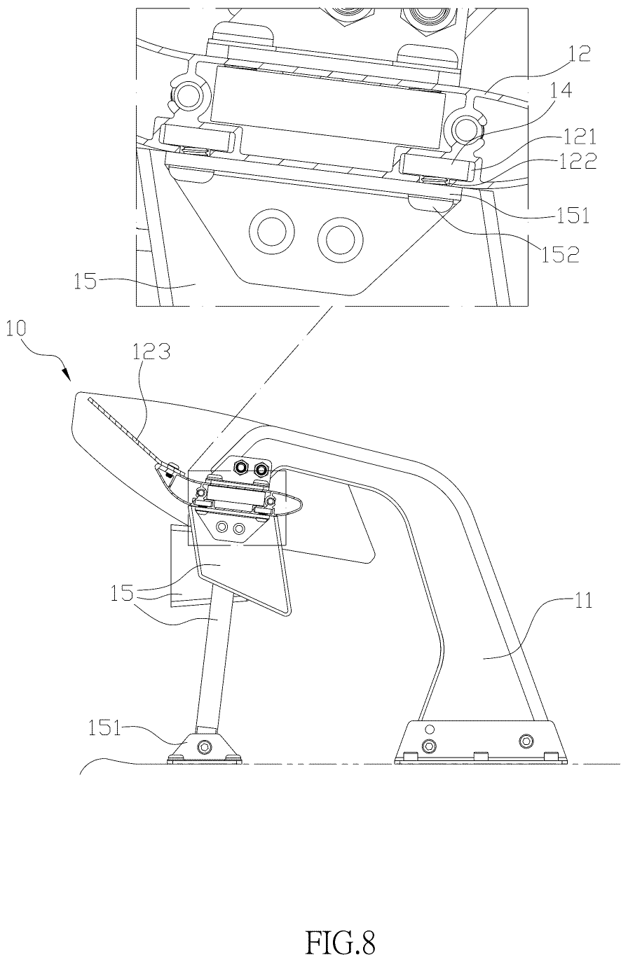

As shown in FIGS. 7 and 8, the at least one attachment piece 15 is a spoiler, and the attachment piece 15 is parallel to a direction in which the vehicle 20 travels.

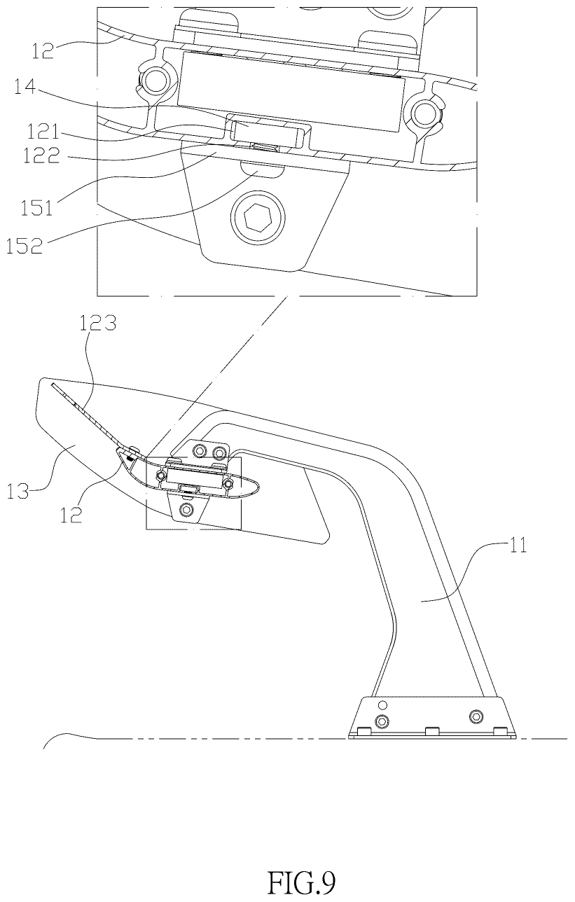

As shown in FIGS. 1 and 8, the at least one track 121 are two tracks, or as shown in FIG. 9, the at least one track 121 is one track.

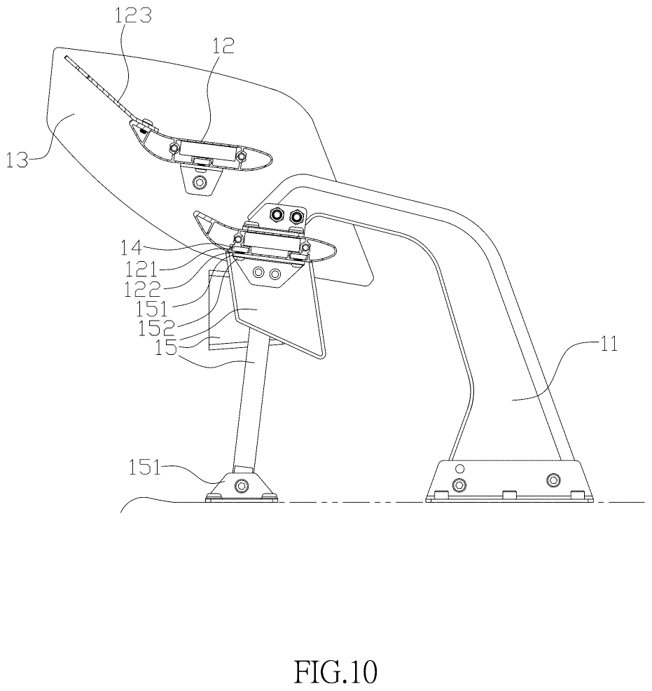

Alternatively, as shown in FIG. 10, the main body 12 has a plurality of pieces, and any number of the rear wing panels 123 can be installed according to the needs to adjust to the best driving state.

With the above structure, since the attachable base block 14 can slide in the track 121, the attachment piece 15 can be fixed to the bottom of the main body 12 along the track 121, so that the attachment piece 15 is easy to install and can be flexibly adjusted. The user can install different types of the attachment piece 15 according to his/her own needs to adjust the structure of the rear wing 10 or use the attachment piece 15 for driving assistance.

In actual application, the attachment piece 15 can be in different forms such as a fog lamp, a rear brake lamp, an adjustment lever or a spoiler, and the user can choose to install it according to his or her own needs. Since the attachment piece 15 is installed at the bottom of the main body 12, the structure of the automobile 20 will not be significantly changed, which greatly reduces the modification cost and limits the modification scope to the rear wing 10.

Although the present invention has been explained in relation to its preferred embodiment, it is to be understood that many other possible modifications and variations can be made without departing from the spirit and scope of invention as hereinafter claimed.

What is claimed is:

1. A car spoiler comprising a rear wing; wherein the rear wing comprises two supporting arms, at least one main body, and two rear wing side parts; the two supporting arms are configured for being attached to a car, the two supporting arms combined with the main body, and a left side and a right side of the main body are respectively combined with each of one rear wing side part; at least one track is provided at a bottom of the main body, a track opening is disposed between the track and a surface of the main body, a plurality of attachable base blocks are slidably attached to the track, and the attachable base blocks are capable of being combined with at least one attachment piece; and each attachment piece has at least one assembly portion locked with the attachment piece through the track opening by a plurality of screws to secure the attachment piece onto a bottom of the main body.

2. The car spoiler as claimed in claim 1, wherein the at least one attachment piece comprises a fog light.

3. The car spoiler as claimed in claim 1, wherein the at least one attachment piece comprises a rear braking light.

4. The car spoiler as claimed in claim 1, wherein the at least one attachment piece is an adjustment lever, both opposite ends of the attachment piece respectively having one assembly portion capable of pivoting relative to the attachment piece, and another end of the assembly portion of the attachment piece is secured to the car.

5. The car spoiler as claimed in claim 1, wherein the at least one attachment piece is a spoiler, and the attachment piece is parallel to a direction in which the vehicle travels.

6. The car spoiler as claimed in claim 1, wherein the at least one track is two tracks.

7. The car spoiler as claimed in claim 1, wherein the at least one track is one track
